(19) United States
(12) Patent Application Publication
(10) Pub. No.: US 2023/0082766 A1
(43) Pub. Date: Mar. 16, 2023

(54) IMAGE SYNCHRONIZATION METHOD AND APPARATUS, AND DEVICE AND COMPUTER STORAGE MEDIUM

(71) Applicant: SENSETIME INTERNATIONAL PTE. LTD., Singapore (SG)

(72) Inventors: Jiacheng WU, Singapore (SG); Dongliang SUN, Singapore (SG); Shuai ZHANG, Singapore (SG)

(21) Appl. No.: 17/490,010

(22) Filed: Sep. 30, 2021

Related U.S. Application Data
(63) Continuation of application No. PCT/IB2021/058759, filed on Sep. 26, 2021.

(30) Foreign Application Priority Data
Sep. 16, 2021 (SG) 10202110230T

(51) Int. Cl. H04N 5/04; H04N 5/247; H04N 5/232

(52) U.S. Cl. CPC H04N 5/04; H04N 5/247; H04N 5/23203; H04N 5/23229

(57) ABSTRACT

Provided are an image synchronization method and apparatus, a device and a computer storage medium. The method includes that: a plurality of groups of candidate images collected by a plurality of image collection apparatuses for a target object and time parameters corresponding to each of the candidate images are acquired; a candidate image is selected from the each group of candidate images to serve as an image to be analyzed, and a group of images to be analyzed is constructed on the basis of a plurality of images to be analyzed; and the group of images to be analyzed is determined as a synchronization image group corresponding to the target object in response to the time parameters of the images to be analyzed all satisfying a preset synchronization condition.

### CROSS-REFERENCE TO RELATED APPLICATION(S)

This is continuation of international application PCT/IB2021/058759, filed on 26 Sep. 2021, which claims priority to Singaporean patent application No. 10202110230T, filed with IPOS on 16 Sep. 2021. The contents of international application PCT/IB2021/058759 and Singaporean patent application No. 10202110230T are incorporated herein by reference in their entireties.

### TECHNICAL FIELD

The disclosure relates to the field of intelligent video analysis, and in particular, to an image synchronization method and apparatus, a device and a computer storage medium.

### BACKGROUND

At present, in specific scenarios such as live broadcasting and board game scenarios, a plurality of cameras arranged at different angle directions are commonly used for cooperative processing, i.e., the cameras are triggered to photograph the same target object at different angles, and return a plurality of images. Then, information analysis and information fusion are performed on the images, so that the seen target object accords with a real visual world of human face vision better. Thus, the cameras need to comply with strict frame synchronization requirements.

However, the images returned by the cameras may not be synchronized at frame level due to time error problems caused by network transmission or the hardware of the cameras.

### SUMMARY

Embodiments of the disclosure provide an image synchronization method and apparatus, a device and a computer storage medium.

The embodiments of the disclosure provide an image synchronize method. The method may include the following operations.

A plurality of groups of candidate images collected by a plurality of image collection apparatuses for a target object and time parameters corresponding to each of the candidate images are acquired. Each of the image collection apparatuses corresponds to one of the plurality of groups of candidate images. Each group of candidate images includes at least one of the candidate images. A candidate image is selected from the each group of candidate images to serve as an image to be analyzed, and a group of images to be analyzed is constructed on the basis of a plurality of images to be analyzed. The group of images to be analyzed is determined as a synchronization image group corresponding to the target object in response to the time parameters of the images to be analyzed all satisfying a preset synchronization condition.

In this way, the group of images to be analyzed constructed on the basis of a candidate image in a group of candidate images collected by each image collection apparatus may be subjected to synchronization determination according to the time parameters by acquiring the plurality of groups of candidate images collected by the plurality of image collection apparatuses for the target object and the time parameters corresponding to each of the candidate images until the synchronization image group with the time parameters all satisfying the preset synchronization condition is determined.

In some embodiments, the method may further include the following operations. Image collection triggering signals are sent to the plurality of image collection apparatuses synchronously. When a candidate image that is returned by any of the image collection apparatuses and is collected in response to the image collection triggering signals are received, the time parameter corresponding to the candidate image is recorded. The candidate images and the time parameters are cached into any image cache queue in a corresponding relationship according to a time parameter ranking sequence, to construct any group of candidate images. Each of the image collection apparatuses corresponds to one image cache queue.

In some embodiments, the operation that the image collection triggering signals are sent to the plurality of image collection apparatuses synchronously includes the following operations. A preset frame frequency corresponding to each of the image collection apparatuses is acquired, and a signal transmission frequency is determined on the basis of the plurality of preset frame frequencies. The signal transmission frequency is less than or equal to any of the preset frame frequencies. The image collection triggering signals are sent to each of the plurality of image collection apparatuses synchronously according to the signal transmission frequency.

In this way, the transmission frequencies of the image collection triggering signals are determined according to the frame frequencies of the image collection apparatuses, which may ensure that more image data is acquired within unit time.

In some embodiments, the operation that a candidate image is selected from the each group of candidate images to serve as an image to be analyzed includes the following operation. A candidate image with a time parameter ranked first is selected from a group of candidate images cached in each image cache queue to serve an image to be analyzed, to obtain the plurality of images to be analyzed.

In some embodiments, after the group of images to be analyzed is constructed on the basis of the plurality of images to be analyzed, and before the group of images to be analyzed is determined as the synchronization image group corresponding to the target object in response to the time parameters of the images to be analyzed all satisfying a preset synchronization condition, the method further includes the following operations. An image to be analyzed with a time parameter ranked last in the group of images to be analyzed is determined as a target image. A time difference value between the time parameter corresponding to the target image and the time parameter corresponding to any other image to be analyzed in the group of images to be analyzed is calculated. In response to the time difference being less than or equal to a preset time threshold value, the time parameters of the images to be analyzed all satisfy the preset synchronization condition.

In this way, the image to be analyzed with the latest time parameter ranking in the group of images to be analyzed is determined as a target image, then the time parameter corresponding to the target image is compared with the time parameter corresponding to any other image to be analyzed, so as to determine a group of frame synchronization images of the target object when the difference values of the time parameters all satisfy a preset error range.

In some embodiments, after the time difference value between the time parameter corresponding to the target image and the time parameter corresponding to any other image to be analyzed in the group of images to be analyzed is calculated, the method further includes the following operations. In response to the time difference value between the time parameter corresponding to the target image and the time parameter corresponding to the first image to be analyzed in the image group to be analyzed being greater than the preset time threshold value, the first image to be analyzed is discarded. The first image to be analyzed is any other image to be analyzed except the target image in the group of images to be analyzed. A second image to be analyzed with a time parameter ranked first is continued to be selected from a first image cache queue to which the first image to be analyzed belongs. The group of images to be analyzed is updated on the basis of the second image to be analyzed, and determination processing of the target image and the determination processing of the preset synchronization condition are continued to be executed on the basis of the updated group of images to be analyzed.

In this way, when there is a difference value of the time parameters that do not satisfy the image to be analyzed in a preset error range, the image to be analyzed is discarded, a new image to be analyzed with the first time parameter is acquired from a corresponding image cache queue to update a group of images to be updated, and the determination of the target image and the determination processing of the preset synchronization condition are repeated, so as to determine image frame synchronization.

In some embodiments, after the group of images to be analyzed is determined as a synchronization image group corresponding to the target object in response to the time parameters of the images to be analyzed all satisfying the preset synchronization condition, the method further includes the following operations. Preprocessing is performed on each image to be analyzed in the synchronization image group to obtain a processed synchronization image group that satisfies a preset model input condition. The processed synchronization image group is input into a target algorithm model to perform image analysis processing.

In some embodiments, after the group of images to be analyzed is determined as a synchronization image group corresponding to the target object in response to the time parameters of the images to be analyzed all satisfying the preset synchronization condition, the method further includes the following operations. The next group of images to be analyzed is continued to be constructed on the basis of the image to be analyzed with the first time parameter of each of the image cache queues, and the determination processing of a next synchronization image group corresponding to the target object is executed.

In some embodiments, the plurality of image collection apparatuses is relatively arranged in a plurality of angle directions of the target object. One image collection apparatus is arranged in one angle direction.

The embodiments of the disclosure provide an image synchronization apparatus. The image synchronization apparatus includes an acquisition module, a selection module, a construction module, and a determination module.

The acquisition module is configured to acquire a plurality of groups of candidate images collected by a plurality of image collection apparatuses for a target object and time parameters corresponding to each of the candidate images. Each of the image collection apparatuses corresponds to one of the plurality of groups of candidate images. Each group of candidate images includes at least one of the candidate images.

The selection module is configured to select one candidate image from the each group of candidate images to serve as an image to be analyzed.

The construction module is configured to construct a group of images to be analyzed on the basis of a plurality of images to be analyzed.

The determination module is configured to determine the group of images to be analyzed as a synchronization image group corresponding to the target object in response to the time parameters of the images to be analyzed all satisfying a preset synchronization condition.

The embodiments of the disclosure provide a computer device, which may include a memory and a processor. The memory may store a computer program capable of running in the processor. The processor may execute the program to implement steps in the method described above.

The embodiments of the disclosure provide a computer-readable storage medium, in which a computer program may be stored. The computer program may be executed by a processor to implement the steps in the method described above.

The embodiments of the disclosure provide an image synchronization method and apparatus, and a device and a storage medium. A group of images to be analyzed constructed on the basis of a candidate image in a group of candidate images collected by each image collection apparatus is subjected to synchronization determination by acquiring a plurality of groups of candidate images collected by a plurality of image collection apparatuses for the target object and time parameters corresponding to each of the candidate images until the synchronization image group with the time parameters all satisfying the preset synchronization condition is determined. Therefore, the images of a plurality of cameras are subjected to synchronization determination on the basis of timestamps, which ensures that a group of images output to an algorithm for detection identification and information infusion by the plurality of cameras are synchronous, and meets a strict frame synchronization requirement.

It is to be understood that the above general description and the following detailed description are only intended to be illustrative and not restrictive, instead of limiting the disclosure.

### BRIEF DESCRIPTION OF THE DRAWINGS

FIG. 1 is an implementation flowchart 1 of an image synchronization method according to an embodiment of the disclosure.

FIG. 2A is an implementation flowchart 2 of an image synchronization method according to an embodiment of the disclosure.

FIG. 2B is an implementation flowchart 3 of an image synchronization method according to an embodiment of the disclosure.

FIG. 3A is an implementation flowchart 4 of an image synchronization method according to an embodiment of the disclosure.

FIG. 3B is an implementation flowchart 5 of an image synchronization method according to an embodiment of the disclosure.

FIG. 4 is a schematic structural diagram of an image synchronization apparatus according to an embodiment of the disclosure.

FIG. 5 is a schematic structural diagram of a computer device according to an embodiment of the disclosure.

### DETAILED DESCRIPTION

The following embodiments are adopted to describe the disclosure rather than limit the scope of the disclosure.

“Some embodiments” involved in the following descriptions describes a subset of all possible embodiments. However, it can be understood that “some embodiments” may be the same subset or different subsets of all the possible embodiments, and may be combined without conflicts.

It is to be pointed out that term “first/second/third” involved in the embodiment of the disclosure is only for distinguishing similar objects and does not represent a specific sequence of the objects. It can be understood that “first/second/third” may be interchanged to specific sequences or orders if allowed to implement the embodiments of the disclosure described herein in sequences except the illustrated or described ones.

Unless otherwise defined, all technical and scientific terms used herein shall have the same meanings as commonly understood by those skilled in the art to which the disclosure belongs. The terms used herein are only intended to describe the embodiments of the disclosure, and are not intended of a limit the disclosure.

Before further describing the embodiments of the disclosure in detail, nouns and terms involved in the embodiment of the disclosure are described. The nouns and terms involved in the embodiment of the disclosure are applicable to the following explanations.

1) Callback function is a function passed as a parameter. The callback literally refers to making a system come back to call a specified function specified by us. A process maybe saved for later use at a specific time.

At present, in specific scenario such as live broadcasting and board game scenarios, a plurality of cameras arranged at different angle directions are commonly used for cooperative processing, i.e., the plurality of cameras are triggered to photograph the same target object at different angles, and return a plurality of images. Then, information analysis and information fusion are performed on the plurality of images, so that the seen target object more accords with a real visual world of human face vision. Thus, the plurality of cameras needs to comply with strict frame synchronization requirements.

However, the plurality of images returned by the plurality of cameras may not be synchronized at frame level due to time error problems caused by network transmission or the hardware of the cameras themselves.

The embodiments of the disclosure provide an image synchronization method and apparatus, and a device and a storage medium. A group of images to be analyzed constructed on the basis of a candidate image in a group of candidate images collected by each image collection apparatus is subjected to synchronization determination by acquiring a plurality of groups of candidate images collected by a plurality of image collection apparatuses for the target object and time parameters corresponding to each of the candidate images until the synchronization image group with the time parameters all satisfying the preset synchronization condition is determined. It can be seen that the images of a plurality of cameras are subjected to synchronization determination on the basis of timestamps, which ensures that a group of images output to an algorithm for detection identification and information infusion by the plurality of cameras are synchronous, and meets a strict frame synchronization requirement.

The embodiments of the disclosure provide an image synchronization method, applied to a computer device. The computer device is deployed with an end-to-end visual model generation platform and a general training framework of an artificial intelligence model that is commonly used in the visual field, such as embedded object detection and image classification.

An exemplary application of the image synchronization apparatus provided by the embodiments of the disclosure is described below. The image synchronization apparatus provided by the embodiments of the disclosure includes, but is not limited to, computers, laptops, tablets, multimedia devices, mobile Internet devices or other types of devices, and devices with computing capacity, such as servers and distributed computing nodes.

The function realized by the method can be realized by calling program codes by the processor in the computer device. Of course, the program codes can be stored in the computer storage medium. It can be seen that the computer device at least includes the processor and the storage medium.

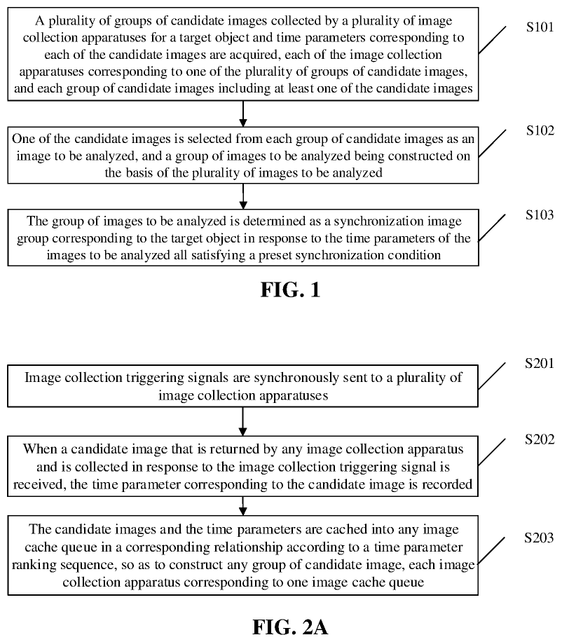

The embodiments of the disclosure provide an image synchronization method. FIG. 1 is an implementation flowchart 1 of an image synchronization method according to an embodiment of the disclosure. As shown in FIG. 1, the method for executing image synchronization includes the following steps.

S101, a plurality of groups of candidate images collected by a plurality of image collection apparatuses for a target object and time parameters corresponding to each of the candidate images are acquired. Each of the image collection apparatuses corresponds to one of the plurality of groups of candidate images. Each group of candidate images includes at least one of the candidate images.

In the embodiment of the disclosure, an image processing apparatus may acquire a plurality of groups of candidate images collected by a plurality of image collection apparatuses for a target object and time parameters corresponding to each frame of the candidate images first.

In some embodiments, the target object refers to a target character in a current scenario (for example, a board game scenario or a stage scenario). The image collection apparatus may be an apparatus, such as a camera, that is independent of the image synchronization apparatus and is configured to photograph the target object.

Here, in order to acquire action information, body feature information or the like in each angle direction of the target task, a plurality of image collection apparatuses may be arranged. The image collection apparatuses are respectively relatively arranged in all angle directions of the target character to photograph the action information and the body feature information of the target character in all angle directions in the current scenario.

In an implementation manner, the plurality of image collection apparatuses all establishes communication connection with the image synchronization apparatus to perform information interaction. Each image collection apparatus may establish wired connection or wireless connection with the image synchronization apparatus, or part of the plurality of image collection apparatuses may establish wired connection with the image synchronization apparatus, and the other part may establish wireless connection with the image synchronization apparatus.

Exemplarily, assuming that the current scenario is a board game scenario, taking the image synchronization apparatus being a computer device and the image collection apparatuses being video cameras as an example, the video cameras are arranged in all angle directions, including top, bottom, front, rear, left, right, etc., in a game platform area of the board game. These video cameras and the computer are located in the same local area network or are all connected to the same wireless hotspot, may perform information interaction with the computer. For example, the computer may send instructions to the video cameras or receive the image data that is returned by the video cameras and is collected for the target character.

In some embodiments, each image collection apparatus has a corresponding device identifier. The image synchronization apparatus may store the images returned by each image collection apparatus respectively according to the device identifier, so as to obtain a plurality of groups of candidate images corresponding to the plurality of image collection apparatuses. In other words, each image collection apparatus corresponds to a group of candidate images. Here, each group of candidate images includes at least one candidate image.

In the embodiment of the disclosure, the image synchronization apparatus may record the time parameter corresponding to each candidate image when receiving the images collected by the plurality of image collection apparatuses for the target object. The candidate images and the time parameters are stored in the form of a corresponding relationship.

The time parameters may be receiving time recorded by the image synchronization apparatus when receiving images, and the time parameters may also be collection time when the image collection apparatuses collect the images. In other words, the time parameters may be receiving timestamps or collection timestamps of the candidate images, which is not specifically limited in the application.

It is to be noted that when the image synchronization apparatus executes the image synchronization method according to the disclosure. The acquired candidate images and the corresponding time parameters may be acquired in time, i.e., the candidate images returned by the image collection apparatuses and the time parameters recorded in time are received in real time. The acquired candidate images and the corresponding time parameters may also be offline, i.e., the candidate images returned by the image collection apparatuses cached historically and the corresponding time parameters recorded historically.

S102, one of the candidate images is selected from each group of candidate images to serve as an image to be analyzed, and a group of images to be analyzed is constructed on the basis of the plurality of images to be analyzed.

In the embodiment of the disclosure, a group of images to be analyzed may be constructed on the basis of one candidate image of each group of candidate images after the plurality of groups of candidate images collected by the plurality of image collection apparatuses for the target object and the time parameter corresponding to each of the candidate images are acquired.

In some embodiments, one candidate image is selected from each group of candidate images collected by each image collection apparatus to serve as an image to be analyzed, so as to construct a group of images to be analyzed on the basis of the plurality of images to be analyzed.

When the image to be analyzed is selected, the image to be analyzed may be selected according to the time parameter ranking sequence, i.e., a candidate image with the first time parameter in each group of candidate images is selected to serve as the image to be analyzed.

S103, the group of images to be analyzed is determined as a synchronization image group corresponding to the target object in response to the time parameters of the images to be analyzed all satisfying a preset synchronization condition.

In the embodiment of the disclosure, the time parameters of the images to be analyzed in the group of images to be analyzed can be subjected to synchronization determination after the image to be analyzed is selected from each group of candidate images to construct the group of images to be analyzed.

In some embodiments, the image synchronization apparatus may preset an image synchronization condition in advance. The synchronization condition refers to that a plurality of images to be analyzed in the group of images to be analyzed is synchronized at frame level. The synchronization condition may be characterized by time parameters. In other words, the images to be analyzed are considered to be synchronized at frame level when the time parameters satisfy a certain condition.

In the embodiment of the disclosure, the image synchronization apparatus may determine whether the time parameter corresponding to each image to be analyzed in the group of images to be analyzed satisfies a synchronization condition, and determine the group of the images to be analyzed as a synchronization image group when the time parameters corresponding to the group of images to be analyzed all satisfy the preset synchronization condition. Here, a plurality of images in the synchronization image group is synchronized at frame level.

It can be understood that the image synchronization apparatus may continue to perform determination processing of a next synchronization image group after a synchronization image group of the target image is acquired.

The image synchronization apparatus may continue select a candidate image from a group of candidate images collected by each image collection apparatus and select a candidate image from the remaining candidate images as the images to be analyzed in the next round. Here, a candidate image with a time parameter ranked first is continued to be selected from each group of remaining candidate images according to the time parameter ranking sequence, a new group of images to be analyzed is constructed on the basis of the plurality of images to be analyzed, and then the determination processing for determining whether the time parameters of the images to be analyzed satisfy the preset synchronization condition is continued to be performed, until the next synchronization image group of the target object is obtained.

After that, the image synchronization methods of above-mentioned S102 and S103 are repeated, and the determination processing of the next synchronization image group of the target object is executed.

In some embodiments, in the embodiment of the disclosure, the image synchronization apparatus may input a synchronization image group into a subsequent algorithm model to perform the processes, such as information analysis and information fusion, after the synchronization image group of the target object is determined.

It can be understood that different algorithm models have different requirements for an image input format. Therefore, in the embodiment of the disclosure, preprocessing, such as image cropping and image format conversion, may be performed on a plurality of frames of synchronization images in the synchronization image group, so as to obtain a plurality of frame synchronization images meeting an input requirement of the algorithm model. The synchronization image group that meets the input requirement of the algorithm model and is synchronized at frame level is input into the algorithm model for performing information analysis and information fusion.

It can be seen that the embodiments of the disclosure provide an image synchronization method. By acquiring a plurality of groups of candidate images collected by a plurality of image collection apparatuses for a target object and time parameters corresponding to each of the candidate images, a group of images to be analyzed constructed on the basis of a candidate image in a group of candidate images collected by each image collection apparatus is subjected to synchronization determination until the synchronization image group with the time parameters all satisfying the preset synchronization condition is determined. It can be seen that the images of a plurality of cameras are subjected to synchronization determination on the basis of timestamps, which ensures that a group of images output to an algorithm for detection identification and information infusion by the plurality of cameras are synchronous, and meets a strict frame synchronization requirement.

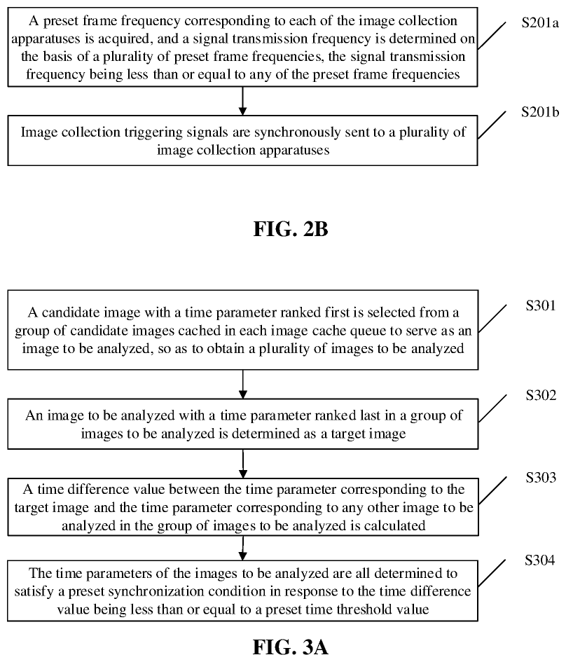

Based on the above-mentioned embodiments, in the embodiment of the disclosure, FIG. 2A is an implementation flowchart 2 of an image synchronization method according to an embodiment of the disclosure. As shown in FIG. 2A, the method for executing image synchronization further includes the following steps.

S201, image collection triggering signals are synchronously sent to a plurality of image collection apparatuses.

In the embodiment of the disclosure, the image synchronization apparatus establishes communication connection with a plurality of image collection apparatuses. In order to facilitate frame synchronization of the images collected by the plurality of image collection apparatuses, the image collection apparatuses may also implement a certain synchronization means, for example, synchronous trigger collection, in an image collection process.

Here, the synchronous trigger collection may be synchronous hard trigger, for example, hardware switches are turned on synchronously to trigger synchronous collection, or the synchronous trigger collection may also be synchronous soft trigger, for example, image collection triggering signals are sent synchronously.

The image synchronization apparatus may facilitate the frame synchronization of the images collected by the plurality of image synchronization apparatuses by means of synchronously sending the image collection triggering signals to the plurality of image collection apparatuses.

In some embodiments, in order to ensure that more images may be collected while the image frames are synchronized, the image synchronization apparatus may determine the frequencies of the image collection triggering signals on the basis of the frame frequencies of the image collection apparatuses.

FIG. 2B is an implementation flowchart 3 of an image synchronization method according to an embodiment of the disclosure. As shown in FIG. 2B, in the embodiment of the disclosure, the method for synchronously sending the image collection triggering signals to the plurality of image collection apparatuses may include the following steps.

S201a, a preset frame frequency corresponding to each of the image collection apparatuses is acquired, and a signal transmission frequency is determined on the basis of a plurality of preset frame frequencies. The signal transmission frequency is less than or equal to any of the preset frame frequencies.

S201b, image collection triggering signals are synchronously sent to a plurality of image collection apparatuses.

It is to be noted that, in the embodiment of the disclosure, the frame frequencies respectively corresponding to the plurality of image collection apparatuses may be the same, or may be different.

In embodiment of the disclosure, in order to ensure that that image collection apparatuses can collect images to the greatest extent, the image synchronization apparatus may acquire the frame frequencies corresponding to a plurality of image collection apparatuses, and determine the transmission frequencies of the image collection triggering signals on the basis of the minimum frame frequency of the plurality of frame frequencies.

In one embodiment, if the frame frequencies respectively corresponding to a plurality of image collection apparatuses are the same, then the magnitude of the frame frequency of any image collection apparatus may be determined as the transmission frequency of the image apparatuses triggering signals. At this time, the transmission frequency of the image apparatuses triggering signals reaches the maximum value of the frame frequency of the image collection apparatuses, so that the image collection apparatuses may acquire more image data within unit time.

In another embodiment, if the frame frequencies respectively corresponding to a plurality of image collection apparatuses are different, then the magnitude of the minimum frame frequency of the image collection apparatuses may be determined as the magnitude of the transmission frequency of the image collection triggering signals. At this time, the transmission frequency of the image collection triggering signals may reach the maximum value under the condition of ensuring good effective collection of the images.

Here, the image synchronization apparatus may synchronously send an image collection triggering signal to a plurality of image collection apparatuses according to the transmission frequency of the signal after the transmission frequency of the image collection triggering signal is determined.

S202, when a candidate image that is returned by any image collection apparatus and is collected in response to the image collection triggering signal is received, the time parameter corresponding to the candidate image is recorded.

In the embodiment of the disclosure, each image collection apparatus may perform image collection processing for a target object in response to the triggering signal after the image synchronization apparatus sends the image collection triggering signals to a plurality of the image collection apparatuses synchronously.

It is to be noted that the plurality of image collection apparatuses may not realize synchronous image collection because the image collection triggering signals do not reach the image collection apparatuses at the same time caused by network transmission; or the plurality of image collection apparatuses may not realize synchronous image collection due to some defects on hardware of the image collection apparatuses.

The image synchronization apparatus may receive images, i.e., candidate images, that are returned by the image collection apparatuses and are collected for the target object after the image collection apparatuses perform the image collection processing for the target object in response to the image collection triggering signals.

In some embodiments, the image collection apparatus may record the collection time of a candidate image, and return the candidate image and the corresponding collection time to the image synchronization apparatus. At this time, the image synchronization apparatus may record the collection time and determine the collection time as a time parameter corresponding to the candidate image.

It can be understood that because the time that the images are transmitted from each image collection apparatus to the image synchronization apparatus is basically the same, in order to reduce the data calculation amount on an image collection apparatus side, in the embodiment of the disclosure, the image synchronization apparatus may record the receiving time when any candidate image returned by any image collection apparatus of a plurality of image collection apparatuses is received, and determine the receiving time as a time parameter corresponding to any candidate image.

Here, because the time that the images are transmitted from each image collection apparatus to the image synchronization apparatus is basically the same, the collection time interval different images may be well represented by an interval of receiving time, and meanwhile, the data calculation amount on the image collection apparatus side may also be lightened.

S203, the candidate images and the time parameters are cached into any image cache queue in a corresponding relationship according to a time parameter ranking sequence, so as to construct any group of candidate images. Each image collection apparatus corresponds to one image cache queue.

A corresponding relationship between each candidate image and the corresponding time parameter may be established and the corresponding relationship is stored after the receiving time corresponding to each candidate image is determined as a time parameter corresponding to the candidate image.

Here, each image collection apparatus has a corresponding device identifier. The image synchronization apparatus can accurately determine which image collection apparatus the candidate image comes from on the basis of the device identifier when the image synchronization apparatus receives the collected image.

In the embodiment of the disclosure, in order to better divide the images collected by a plurality of image collection apparatuses, the image synchronization apparatus may divide a storage area for each image collection apparatus to store the corresponding relationship between the candidate image and the time parameter returned by the image collection apparatus. Each storage area may be divided by using the device identifier of the image collection apparatus.

It can be understood that the later the image collection time, the later the time that the image synchronization apparatus receives the returned images. In order to better standardize the image collection time or receiving time, the image synchronization apparatus sets an image cache queue for each image collection apparatus to store images. Here, each image cache queue follows a first-in first-out rule. The corresponding relationships between the candidate images and the time parameters are stored according to the time parameter ranking sequence.

In other words, each image cache queue is used to store a group of candidate images obtained by photographing the target object in an angle direction by each image collection apparatus.

In the embodiment of the disclosure, the image synchronization apparatus may introduce a callback function during the execution of a relevant code. The content of the callback function is to record an image receiving timestamp, and store an image and the timestamp in a corresponding image cache queue in a form of a corresponding relationship.

Here, the callback function may be set after a code step of receiving a candidate image returned by an image collection apparatus. Thus, when a candidate image returned by any image collection apparatus is received every time, the receiving time of the candidate image, that is, the time parameter corresponding to the candidate image, may be recorded through the callback function, and the candidate image and the time parameter may be stored in an image cache queue corresponding to the image collection apparatus in the form of a corresponding relationship.

It can be seen that, in the embodiment of the disclosure, the transmission frequencies of the image collection triggering signals are determined according to the frame frequencies of the image collection apparatuses, which may ensure that more image data is acquired within unit time.

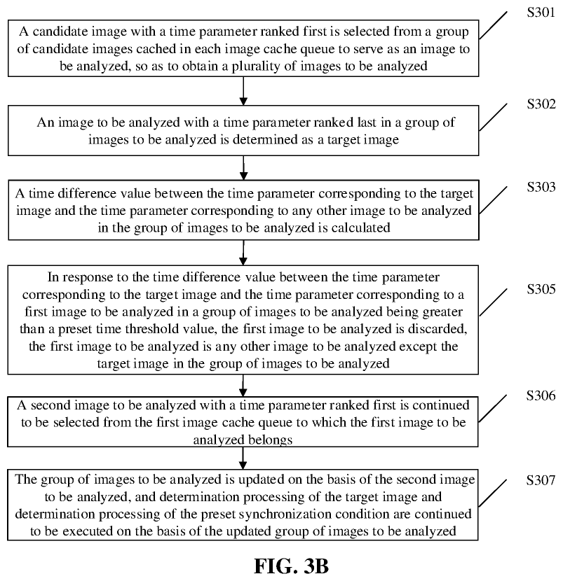

Based on the above-mentioned embodiments, in another embodiment of the disclosure, FIG. 3A is an implementation flowchart 4 of an image synchronization method according to an embodiment of the disclosure. As shown in FIG. 3A, the method for executing image synchronization may include the following steps.

S301, a candidate image with a time parameter ranked first is selected from a group of candidate images cached in each image cache queue to serve as an image to be analyzed, so as to obtain a plurality of images to be analyzed.

S302, an image to be analyzed with a time parameter ranked last in a group of images to be analyzed is determined as a target image.

S303, a time difference value between the time parameter corresponding to the target image and the time parameter corresponding to any other image to be analyzed in the group of images to be analyzed is calculated.

S304, the time parameters of the images to be analyzed are all determined to satisfy a preset synchronization condition in response to the time difference value being less than or equal to a preset time threshold value.

In the embodiment of the disclosure, a candidate image may be selected from the image cache queue used to store the candidate images of the image collection apparatuses to serve as an image to be analyzed in a process of performing frame synchronization determination on the images collected by the plurality of image collection apparatuses.

It can be understood that the processing and analysis of an image are executed according to an image collection time sequence. Here, a candidate image with a time parameter ranked first may be selected from a group of candidate images in each image cache queue to serve as an image to be analyzed according to an image cache rule of the image cache queue described in the image synchronization methods of above-mentioned S201 to S202, and a group of images to be analyzed is constructed on the basis of the plurality of images to be analyzed.

Then, the image synchronization apparatus may determine one of the plurality of images to be analyzed from the group of images to be analyzed as a target image, and then determine the frame synchronization of the plurality of images to be analyzed on the basis of the time difference value between the time parameter corresponding to the target image and the time parameter corresponding to any other remaining images to be analyzed.

The target image may be an image to be analyzed with a time parameter ranked last of a plurality of images to be analyzed. In other words, the time that the image synchronization apparatus receives the target image is the latest. The target image may also be the image to be analyzed with the time parameter ranked last of the plurality of images to be analyzed, or an image to be analyzed with a time parameter ranking in the middle, which is not specifically limited in the application.

In a case where the target image is the image to be analyzed with the time parameter ranked last of the plurality of images to be analyzed, the time difference value between the time parameter corresponding to the target image and the time parameter corresponding to every other image to be analyzed is calculated, and whether the time parameter corresponding to each image to be analyzed satisfies a preset synchronization condition is determined on the basis of a comparison result between each time difference value and a preset time threshold value.

Here, the preset time threshold value is a difference value error range, which is preset by the image synchronization apparatus, of the time parameters that satisfy a preset frame synchronization condition. The preset time threshold value may be set on the basis of the frame rate of a camera, for example, the preset time threshold value set for the camera with the frame frequency of 10 frames per second (FPS) may be 20 ms.

In a case where the time difference value between the time parameter corresponding to the target image and the time parameter corresponding to each image to be analyzed is less than or equal to the preset time threshold value, the time parameter corresponding to each image to be analyzed may be determined to satisfy a preset synchronization condition, i.e., the plurality of images to be analyzed are synchronized at frame level, and then the group of images to be analyzed may be determined as a synchronization image group.

Thus, in the embodiment of the disclosure, an image to be analyzed may be selected from each cache queue to construct a group of images to be analyzed when the frame synchronization of a plurality of images collected by a plurality of image collection apparatus is determined, and an image to be analyzed with a time parameter ranked last is determined as a target image. Then, the time parameter corresponding to the target image is compared with the time parameter corresponding to any other image to be analyzed, so as to determine a group of frame synchronization images of the target object when the difference values of the time parameters all satisfy a preset error range.

Based on the above-mentioned embodiments, in another embodiment of the disclosure, FIG. 3B is an implementation flowchart 5 of an image synchronization method according to an embodiment of the disclosure. As shown in FIG. 3B, after the time difference value between the time parameter corresponding to the target image and the time parameter corresponding to any other image to be analyzed is calculated, i.e., after S303, the method for executing image synchronization 3 may further also the following steps.

S305, in response to the time difference value between the time parameter corresponding to the target image and the time parameter corresponding to a first image to be analyzed in a group of images to be analyzed being greater than a preset time threshold value, the first image to be analyzed is discarded. The first image to be analyzed is any other image to be analyzed except the target image in the group of images to be analyzed.

S306, a second image to be analyzed with a time parameter ranked first is continued to be selected from the first image cache queue to which the first image to be analyzed belongs.

S307, the group of images to be analyzed is updated on the basis of the second image to be analyzed, and determination processing of the target image and determination processing of the preset synchronization condition are continued to be executed on the basis of the updated group of images to be analyzed.

In a case where the target image is the image to be analyzed with the time parameter ranked last of the plurality of images to be analyzed, the time difference value between the time parameter corresponding to the target image and the time parameter corresponding to every other image to be analyzed is calculated. In a case where the time difference value between the time parameter corresponding to one or more images to be analyzed in the group of images to be analyzed and the time parameter corresponding to the target image is greater than a preset time threshold value, the time parameters corresponding to the other one or more images to be analyzed may be determined not to satisfy the preset synchronization condition.

In addition, if the time difference value between the time parameters of the remaining images to be analyzed and the target image is less than or equal to the preset time threshold value, the remaining images to be analyzed may be determined to satisfy the preset synchronization condition.

Here, the image synchronization apparatus may discard one or more other images to be analyzed that do not satisfy the preset synchronization condition, and then continue to select a next candidate image from the image cache queue to which the images to be analyzed not satisfying the preset synchronization condition belongs as an image to be analyzed. The next image to be analyzed is still the image with the time parameter ranked first in the image cache queue to which the image belongs.

In some embodiments, the group of images to be analyzed may be updated on the basis of the newly selected image to be analyzed, the image to be analyzed that satisfies the preset frame synchronization in the previous round, and the target image in the previous round, i.e., a new group of images to be analyzed is reconstructed. Here, the images to be analyzed still include one candidate image with a time parameter ranked first selected from a group of candidate images of each image cache queue.

In the embodiment of the disclosure, determination processing of the new target image may be continued to be performed on the basis of the updated group of images to be analyzed, and determination processing to determine whether the target image satisfies the preset synchronization condition may be executed on the basis of the time parameter corresponding to the image to be analyzed In other words, the image synchronization methods of S302, S303, and S304 are executed circularly, or the image synchronization methods of S302, S303, S305, S306 and S307 are executed circularly, so as to determine a synchronization image group of the target object.

Thus, in the embodiment of the disclosure, an image to be analyzed with a time parameter ranked first may be determined as a target image from the group of images to be analyzed, and then the time parameter corresponding to the target image and the time parameter corresponding to any other image to be analyzed may be compared. When there is a difference value of the time parameters that do not satisfy the image to be analyzed in a preset error range, the image to be analyzed is discarded, a new image to be analyzed with the first time parameter is acquired from a corresponding image cache queue to update a group of images to be updated, and the determination of the target image and the determination processing of the preset synchronization condition are repeated, so as to determine image frame synchronization.

Based on the above-mentioned embodiments, in another embodiment of the disclosure, the method for executing image synchronization may include the following steps.

S401, a preset frame frequency corresponding to each image collection apparatus of a plurality of image collection apparatuses is acquired, and a signal transmission frequency is determined on the basis of a plurality of preset frame frequencies. The signal transmission frequency is less than or equal to any preset frame frequency.

S402, image collection triggering signals are synchronously sent to a plurality of image collection apparatuses according to the signal transmission frequency.

S403, when a candidate image that is returned by any image collection apparatus and is collected in response to the image collection triggering signal is received, the time parameter corresponding to a candidate image is recorded.

S404, the candidate images and the time parameters are cached into any image cache queue in a corresponding relationship according to a time parameter ranking sequence, so as to construct any group of candidate images. Each image collection apparatus corresponds to one image cache queue.

S405, a candidate image with a time parameter ranked first is respectively selected to serve as an image to be analyzed from a group of candidate images cached in each image cache queue to obtain a plurality of images to be analyzed, and a group of images to be analyzed is constructed on the basis of the plurality of images to be analyzed.

S406, a candidate image with a time parameter ranked last in the group of images to be analyzed is determined as a target image.

S407, a time difference value between the time parameter corresponding to the target image and the time parameter corresponding to any image to be analyzed in the group of images to be analyzed is calculated.

S408, whether the time difference value satisfies a preset time threshold value is determined. If the preset time threshold value is satisfied, S409 is executed. If the preset time threshold value is not satisfied, S411 is executed.

S409, the time parameters of the images to be analyzed are all determined to satisfy the preset synchronization condition, the group of images to be analyzed is determined as a synchronization image group corresponding to the target object.

S410, preprocessing is preformed on each image to be analyzed in the synchronization image group, so as to obtain a processed synchronization image group that satisfies a preset model input condition. The processed synchronization image group is input into a target algorithm model to perform image analysis processing.

S411, a first image to be analyzed, of which the time parameter has the time difference value greater than a preset time threshold value with respect to the time parameter corresponding to the target image, is discarded. The first image to be analyzed is any other image to be analyzed except the target image in the group of images to be analyzed.

S412, a second image to be analyzed with a time parameter ranked first is continued to be selected from the first image cache queue to which the first image to be analyzed belongs.

S413, the group of images to be analyzed is updated on the basis of the second image to be analyzed, and S406 to S413 are executed circularly.

It can be seen that, based on the image synchronization methods of S401 to S412, by acquiring the plurality of groups of candidate images collected by the plurality of image collection apparatuses for the target object and the time parameters corresponding to each of the candidate images, the group of images to be analyzed constructed on the basis of a candidate image in a group of candidate images collected by each image collection apparatus may be subjected to synchronization determination according to the time parameters until a synchronization image group with the time parameters all satisfying the preset synchronization condition is determined. It can be seen that the image frames of a plurality of cameras are subjected to synchronization determination on the basis of timestamps, which ensures that a group of image frames output to an algorithm for detection identification and information infusion by the plurality of cameras are synchronous, and meets a strict frame synchronization requirement.

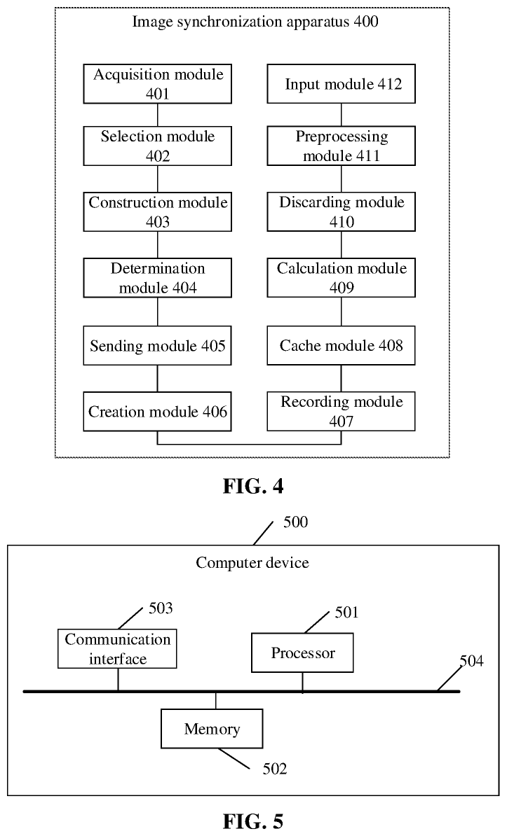

The embodiments of the disclosure provide an image synchronization apparatus. FIG. 4 is a schematic structural diagram of an image synchronization apparatus according to an embodiment of the disclosure. As shown in FIG. 4, the image synchronization apparatus 400 includes an acquisition module 401, a selection module 402, a construction module 403, and a determination module 404.

The acquisition module 401 is configured to acquire a plurality of groups of candidate images collected by a plurality of image collection apparatuses for a target object and time parameters corresponding to each of the candidate images. Each of the image collection apparatuses corresponds to one of the plurality of groups of candidate images. Each group of candidate images includes at least one of the candidate images.

The selection module 402 is configured to select one candidate image from the each group of candidate images to serve as an image to be analyzed.

The construction module 403 is configured to construct a group of images to be analyzed on the basis of a plurality of images to be analyzed.

The determination module 404 is configured to determine the group of images to be analyzed as a synchronization image group corresponding to the target object in response to the time parameters of the images to be analyzed all satisfying a preset synchronization condition.

In some embodiments, the image synchronization apparatus 400 further includes a sending module 405, which is configured to send image collection triggering signals to the plurality of image collection apparatuses synchronously.

In some embodiments, a recording module 406 is configured to record the time parameter corresponding to a candidate image when the candidate image that is returned by any of the image collection apparatuses and is collected in response to the image collection triggering signals is received.

In some embodiments, a cache module 407 is configured to cache the candidate images and the time parameters into any image cache queue in a corresponding relationship according to a time parameter ranking sequence, so as to construct any group of candidate images. Each image collection apparatus corresponds to one image cache queue.

In some embodiments, the sending module 405 is specifically configured to acquire a preset frame frequency corresponding to each of the image collection apparatuses, and determine a signal transmission frequency on the basis of a plurality of preset frame frequencies, the signal transmission frequency being less than or equal to any of the preset frame frequencies; and synchronously send image collection triggering signals to the plurality of image collection apparatuses according to the signal transmission frequency.

In some embodiments, the selection module 402 is configured to select a candidate image with a time parameter ranked first from a group of candidate images cached in each image cache queue as an image to be analyzed, so as to obtain the plurality of images to be analyzed.

In some embodiments, the determination module 404 is further configured to determine an image to be analyzed with a time parameter ranked last in the group of images to be analyzed as a target image after the group of images to be analyzed is constructed on the basis of the plurality of images to be analyzed, and before the group of images to be analyzed is determined as the synchronization image group corresponding to the target object in response to the time parameters of the images to be analyzed all satisfying a preset synchronization condition.

In some embodiments, a calculation module 408 is configured to calculate a time difference value between the time parameter corresponding to the target image and the time parameter corresponding to any image to be analyzed in the group of images to be analyzed.

In some embodiments, the determination module 404 is further configured to determine that the time parameters of the images to be analyzed all satisfy a preset synchronization condition in response to the time difference value being less than or equal to a preset time threshold value.

In some embodiments, a discarding module 409 is configured to discard a first image to be analyzed in response to the time difference value between the time parameter corresponding to the target image and the time parameter corresponding to the first image to be analyzed being greater than the preset time threshold value after the time difference value between the time parameter corresponding to the target image and the time parameter corresponding to any other image to be analyzed is calculated. The first image to be analyzed is any other image to be analyzed except the target image in the group of images to be analyzed.

In some embodiments, the selection module 402 is further configured to continue to select a second image to be analyzed with a time parameter ranked first from the first image cache queue to which the first image to be analyzed belongs.

In some embodiments, an updating module 410 is configured to update the group of images to be analyzed on the basis of the second image to be analyzed, and continue to execute determination processing of the target image and determination processing of the preset synchronization condition on the basis of the updated group of images to be analyzed.

In some embodiments, a preprocessing module 411 is configured to perform preprocessing on each image to be analyzed in the synchronization image group, so as to obtain a processed synchronization image group that satisfies a preset model input condition.

In some embodiments, an input module 412 is configured to input the processed synchronization image group into a target algorithm model to perform image analysis processing.

In some embodiments, the construction module 403 is further configured to construct a next group of images to be analyzed on the basis of the image to be analyzed with a time parameter ranked first of each of the image cache queues, and execute the determination processing of a next synchronization image group corresponding to the target object.

In some embodiments, the plurality of image collection apparatuses is relatively arranged in a plurality of angle directions of the target object. Each image collection apparatus is arranged in one angle direction.

It is to be noted that the above descriptions about the apparatus embodiments are similar to descriptions about the method embodiments and beneficial effects similar to those of the method embodiments are achieved. Technical details undisclosed in the apparatus embodiments of the disclosure may be understood with reference to the descriptions about the method embodiments of the disclosure.

It is to be noted that, in the embodiment of the disclosure, when implemented in form of a software functional module and sold or used as an independent product, the above-mentioned image synchronization method may also be stored in a computer-readable storage medium. Based on such an understanding, the embodiments of the disclosure substantially or parts making contributions to the related art may be embodied in a form of a software product. The computer software product is stored in a storage medium, including a plurality of instructions configured to enable an electronic device (which may be a terminal, a server, etc.) to execute all or part of the method in each embodiment of the disclosure. The above-mentioned storage medium includes: various media capable of storing program codes, such as a USB flash drive, a mobile hard disc, a Read-Only Memory (ROM), a magnetic disc, or a compact disc. Therefore, the embodiments of the disclosure are not limited to any specific hardware and software combination.

Correspondingly, the embodiments of the application further provide a computer program product. The computer program product includes a computer executable instruction. The computer executable instruction can implement the steps in the image synchronization method provided by the embodiments of the disclosure after being executed.

The embodiments of the application further provide a computer storage medium. The computer storage medium stores a computer executable instruction. The computer executable instruction can implement the steps in the image synchronization method provided by the embodiments of the disclosure when being executed by the processor.

FIG. 5 is a schematic structural diagram of a computer device according to an embodiment of the disclosure. As shown in FIG. 5, the computer device 500 according to the embodiment of the disclosure may further include a processor 501 and a memory 502 that stores a computer executable instruction. Further, the computer device 500 may further include a communication interface 503, and a bus 504 configured to connect the processor 501, the memory 502, and the communication interface 503.

In the embodiment of the disclosure, the above-mentioned processor 501 may be at least one of an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing Unit (CPU), a controller, a microcontroller, or an MPU. It can be understood that other electronic devices may also be configured to realize functions of the processor for different devices, which is not specifically limited in the embodiment of the disclosure. The computer device 500 may also include a memory 502. The memory 502 may be connected to the processor 501. The memory 502 is configured to store an executable program code. The program code includes a computer operation instruction. The memory 502 may include high-speed RAM memory, and may also include a nonvolatile memory, for example, at least two magnetic disc memories.

In the embodiment of the disclosure, the bus 504 is configured to connect the communication interface 503, the processor 501, and the memory 502, and is configured to mutual communication among these devices.

In the embodiment of the disclosure, the memory 502 is configured to store an instruction and data.

Further, in the embodiment of the disclosure, the above-mentioned processor 501 is configured to execute the above-mentioned image synchronization method. The method is shown as follows.

A plurality of groups of candidate images collected by a plurality of image collection apparatuses for a target object and time parameters corresponding to each of the candidate images are acquired. Each of the image collection apparatuses corresponds to one of the plurality of groups of candidate images. Each group of candidate images includes at least one of the candidate images.

One of the candidate images is selected from the each group of candidate images to serve as an image to be analyzed, and a group of images to be analyzed is constructed on the basis of the plurality of images to be analyzed.

The group of images to be analyzed is determined as a synchronization image group corresponding to the target object in response to the time parameters of the images to be analyzed all satisfying a preset synchronization condition.

In practical application, the above-mentioned memory 502 may be a volatile memory, for example, a Random-Access Memory (RAM), or a non-volatile memory, for example, a Read-Only Memory (ROM), a flash memory, a Hard Disc Driver (HDD), or a Solid-State Drive (SSD), or a combination of the above-mentioned types of memories, and provides an instruction and data for the processor 501.

In addition, various functional modules in the embodiments may be integrated into one recommended unit, or each of the units may exist separately physically, or two or more units are integrated into one unit. The integrated unit may be implemented in a form of hardware, or may be implemented in a form of a software functional module.

When the integrated unit is implemented in the form of software function module and is not sold or used as an independent product, it can be stored in a computer readable storage medium. Based on such an understanding, all or some of the embodiments may be implemented in a form of a software product. The software product is stored in a storage medium and includes several instructions for instructing a computer device (which may be a personal computer, a server, a network device, or the like) or a processor (processor) perform all or some of the steps of the methods described in the embodiments. The foregoing storage medium includes: various media capable of storing program codes, such as a USB flash disc, a mobile hard disc, a Read Only Memory (ROM), a magnetic disc, or a compact disc.

The embodiments of the disclosure provide an image synchronization apparatus. By acquiring a plurality of groups of candidate images collected by a plurality of image collection apparatuses for the target object and time parameters corresponding to each of the candidate images, a group of images to be analyzed constructed on the basis of a candidate image in a group of candidate images collected by each image collection apparatus may be subjected to synchronization determination according to the time parameters until the synchronization image group with the time parameters all satisfying the preset synchronization condition is determined. It can be seen that the image frames of a plurality of cameras are subjected to synchronization determination on the basis of timestamps, which ensures that a group of image frames output to an algorithm for detection identification and information infusion by the plurality of cameras are synchronous, and meets a strict frame.

The embodiment of the disclosure provides a computer-readable storage medium, on which a program is stored. The computer program is executed by a processor to implement the previously described image synchronization method.

Specifically, a computer program instruction corresponding to an image synchronization method in the embodiment may be stored in storage media, such as a compact disc, a hard disc, and a USB flash disc. When the computer program instruction corresponding to the image synchronization method in the storage medium is read or executed by an electronic device, the above-mentioned image synchronization method is implemented.

Correspondingly, the embodiments of the disclosure further provide a computer program medium, including a computer executable instruction. The computer executable instruction may execute the steps of an image processing method according to the embodiments of the disclosure.

Those skilled in the art should understand that the embodiments of the disclosure can provide a method, a system or a computer program product. Thus, forms of hardware embodiments, software embodiments or embodiments integrating software and hardware can be adopted in the disclosure. Moreover, a form of the computer program product implemented on one or more computer available storage media (including, but not limited to, a disc memory, an optical memory and the like) containing computer available program codes can be adopted in the disclosure.

The disclosure is described with reference to flowcharts and/or block diagrams of the method, the device (system) and the computer program product according to the embodiments of the disclosure. It should be understood that each flow and/or block in the flowcharts and/or the block diagrams and a combination of the flows and/or the blocks in the flowcharts and/or the block diagrams can be realized by computer program instructions. These computer program instructions can be provided for a general computer, a dedicated computer, an embedded processor or processors of other programmable data processing devices to generate a machine, so that an apparatus for realizing functions assigned in one or more flows of the flowcharts and/or one or more blocks of the block diagrams is generated via instructions executed by the computers or the processors of the other programmable data processing devices.

These computer program instructions can also be stored in a computer readable memory capable of guiding the computers or the other programmable data processing devices to work in a specific mode, so that a manufactured product including an instruction apparatus is generated via the instructions stored in the computer readable memory, and the instruction apparatus realizes the functions assigned in one or more flows of the flowcharts and/or one or more blocks of the block diagrams.

These computer program instructions can also be loaded to the computers or the other programmable data processing devices, so that processing realized by the computers is generated by executing a series of operation steps on the computers or the other programmable devices, and therefore the instructions executed on the computers or the other programmable devices provide a step of realizing the functions assigned in one or more flows of the flowcharts and/or one or more blocks of the block diagrams.

The foregoing descriptions are only some embodiments of the disclosure and are not intended to limit the scope of protection of the disclosure.

What is claimed is:

1. An image synchronization method, comprising:
acquiring a plurality of groups of candidate images collected by a plurality of image collection apparatuses for a target object and time parameters corresponding to each of the candidate images, wherein each of the image collection apparatuses corresponds to one of the plurality of groups of candidate images, and each group of candidate images includes at least one of the candidate images;
selecting one of the candidate images from the each group of candidate images as an image to be analyzed, and constructing a group of images to be analyzed on the basis of a plurality of images to be analyzed; and
determining the group of images to be analyzed as a synchronization image group corresponding to the target object in response to the time parameters of the images to be analyzed all satisfying a preset synchronization condition.

2. The method of claim 1, further comprising:
synchronously sending image collection triggering signals to a plurality of image collection apparatuses;
in a case where a candidate image that is returned by any of the image collection apparatuses and is collected in response to the image collection triggering signals is received, recording the time parameter corresponding to the candidate image; and
caching the candidate images and the time parameters into any image cache queue in a corresponding relationship according to the time parameter ranking sequence to construct any group of candidate images, wherein each of the image collection apparatuses corresponds to one image cache queue.

3. The method of claim 2, wherein the synchronously sending image collection triggering signals to a plurality of image collection apparatuses comprises:
acquiring a preset frame frequency corresponding to each of the image collection apparatuses, and determining a signal transmission frequency on the basis of a plurality of preset frame frequencies, wherein the signal transmission frequency is less than or equal to any of the preset frame frequencies; and
synchronously sending the image collection triggering signals to the plurality of image collection apparatuses according to the signal transmission frequency.

4. The method of claim 2, wherein the selecting one of the candidate images from the each group of candidate images as an image to be analyzed comprises:
selecting a candidate image with a time parameter ranked first from a group of candidate images cached in each image cache queue as an image to be analyzed, to obtain the plurality of images to be analyzed.

5. The method of claim 4, after the constructing a group of images to be analyzed on the basis of the plurality of images to be analyzed, and before the determining the group of images to be analyzed as a synchronization image group corresponding to the target object in response to the time parameters of the images to be analyzed all satisfying a preset synchronization condition, further comprising:
determining an image with a time parameter ranked last in the group of images to be analyzed as a target image;
calculating a time difference value between a time parameter corresponding to the target image and a time parameter corresponding to any image to be analyzed in the group of images to be analyzed; and
determining that the time parameters of the images to be analyzed all satisfy a preset synchronization condition in response to the time difference value being less than or equal to a preset time threshold value.

6. The method of claim 5, after the calculating a time difference value between a time parameter corresponding to the target image and a time parameter corresponding to any image to be analyzed in the group of images to be analyzed, further comprising:
in response to the time difference value between the time parameter corresponding to the target image and a time parameter corresponding to a first image to be analyzed in the image group to be analyzed being greater than the preset time threshold value, discarding the first image to be analyzed, wherein the first image to be analyzed is any other image to be analyzed except the target image in the group of images to be analyzed;
continuing to select a second image to be analyzed with a time parameter ranked first from a first image cache queue to which the first image to be analyzed belongs; and
updating the group of images to be analyzed on the basis of the second image to be analyzed, and continuing to execute determination processing of the target image and determination processing of the preset synchronization condition on the basis of the updated group of images to be analyzed.

7. The method of claim 1, after the determining the group of images to be analyzed as a synchronization image group corresponding to the target object in response to the time parameters of the images to be analyzed all satisfying a preset synchronization condition, further comprising:
performing preprocessing on each image to be analyzed in the synchronization image group to obtain a processed synchronization image group that satisfies a preset model input condition; and
inputting the processed synchronization image group into a target algorithm model to perform image analysis processing.

8. The method of claim 2, after the determining the group of images to be analyzed as a synchronization image group corresponding to the target object in response to the time parameters of the images to be analyzed all satisfying a preset synchronization condition, further comprising:
constructing a next group of images to be analyzed on the basis of the image to be analyzed with a time parameter ranked first of each of the image cache queues, and executing the determination processing of a next synchronization image group corresponding to the target object.

9. The method of claim 1, wherein the plurality of image collection apparatuses are relatively arranged in a plurality of angle directions of the target object, each image collection apparatus being arranged in one angle direction.

10. A computer device, comprising a memory and a processor, wherein the memory stores a computer program capable of running in the processor, and wherein when executing the computer program, the processor is configured to:
acquire a plurality of groups of candidate images collected by a plurality of image collection apparatuses for a target object and time parameters corresponding to each of the candidate images, wherein each of the image collection apparatuses corresponds to one of the plurality of groups of candidate images, and each group of candidate images includes at least one of the candidate images;
select one of the candidate images from the each group of candidate images as an image to be analyzed, and construct a group of images to be analyzed on the basis of a plurality of images to be analyzed; and
determine the group of images to be analyzed as a synchronization image group corresponding to the target object in response to the time parameters of the images to be analyzed all satisfying a preset synchronization condition.

11. The computer device of claim 10, wherein the processor is further configured to:
synchronously send image collection triggering signals to a plurality of image collection apparatuses;
in a case where a candidate image that is returned by any of the image collection apparatuses and is collected in response to the image collection triggering signals is received, record the time parameter corresponding to the candidate image; and
cache the candidate images and the time parameters into any image cache queue in a corresponding relationship according to the time parameter ranking sequence to construct any group of candidate images, wherein each of the image collection apparatuses corresponds to one image cache queue.

12. The computer device of claim 11, wherein when synchronously sending the image collection triggering signals to the plurality of image collection apparatuses, the processor is configured to:
acquire a preset frame frequency corresponding to each of the image collection apparatuses, and determine a signal transmission frequency on the basis of a plurality of preset frame frequencies, wherein the signal transmission frequency is less than or equal to any of the preset frame frequencies; and
synchronously send the image collection triggering signals to the plurality of image collection apparatuses according to the signal transmission frequency.

13. The computer device of claim 11, wherein when selecting one of the candidate images from the each group of candidate images as the image to be analyzed, the processor is configured to:
select a candidate image with a time parameter ranked first from a group of candidate images cached in each image cache queue as an image to be analyzed, to obtain the plurality of images to be analyzed.

14. The computer device of claim 13, after constructing the group of images to be analyzed on the basis of the plurality of images to be analyzed, and before determining the group of images to be analyzed as the synchronization image group corresponding to the target object in response to the time parameters of the images to be analyzed all satisfying the preset synchronization condition, the processor is further configured to:
determine an image with a time parameter ranked last in the group of images to be analyzed as a target image;
calculate a time difference value between a time parameter corresponding to the target image and a time parameter corresponding to any image to be analyzed in the group of images to be analyzed; and
determine that the time parameters of the images to be analyzed all satisfy a preset synchronization condition in response to the time difference value being less than or equal to a preset time threshold value.

15. The computer device of claim 14, after calculating the time difference value between the time parameter corresponding to the target image and the time parameter corresponding to any image to be analyzed in the group of images to be analyzed, the processor is further configured to:
in response to the time difference value between the time parameter corresponding to the target image and a time parameter corresponding to a first image to be analyzed in the image group to be analyzed being greater than the preset time threshold value, discard the first image to be analyzed, wherein the first image to be analyzed is any other image to be analyzed except the target image in the group of images to be analyzed;
continue to select a second image to be analyzed with a time parameter ranked first from a first image cache queue to which the first image to be analyzed belongs; and
update the group of images to be analyzed on the basis of the second image to be analyzed, and continue to execute determination processing of the target image and determination processing of the preset synchronization condition on the basis of the updated group of images to be analyzed.

16. The computer device of claim 10, after determining the group of images to be analyzed as the synchronization image group corresponding to the target object in response to the time parameters of the images to be analyzed all satisfying the preset synchronization condition, the processor is further configured to:
perform preprocessing on each image to be analyzed in the synchronization image group to obtain a processed synchronization image group that satisfies a preset model input condition; and
input the processed synchronization image group into a target algorithm model to perform image analysis processing.

17. The computer device of claim 11, after determining the group of images to be analyzed as the synchronization image group corresponding to the target object in response to the time parameters of the images to be analyzed all satisfying the preset synchronization condition, the processor is further configured to:
construct a next group of images to be analyzed on the basis of the image to be analyzed with a time parameter ranked first of each of the image cache queues, and execute the determination processing of a next synchronization image group corresponding to the target object.

18. The computer device of claim 10, wherein the plurality of image collection apparatuses are relatively arranged in a plurality of angle directions of the target object, each image collection apparatus being arranged in one angle direction.

19. A computer-readable storage medium, having a computer program stored thereon, wherein the computer program, when executed by a processor, is configured to:
acquire a plurality of groups of candidate images collected by a plurality of image collection apparatuses for a target object and time parameters corresponding to each of the candidate images, wherein each of the image collection apparatuses corresponds to one of the plurality of groups of candidate images, and each group of candidate images includes at least one of the candidate images;
select one of the candidate images from the each group of candidate images as an image to be analyzed, and construct a group of images to be analyzed on the basis of a plurality of images to be analyzed; and
determine the group of images to be analyzed as a synchronization image group corresponding to the target object in response to the time parameters of the images to be analyzed all satisfying a preset synchronization condition.
